(19) United States
(12) Patent Application Publication
(10) Pub. No.: US 2026/0099254 A1
(43) Pub. Date: Apr. 9, 2026

(54) STORAGE DEVICE FOR WRITING DATA TO SUPER MEMORY BLOCKS CORRESPONDING TO TAGS, AND METHOD FOR OPERATING THE STORAGE DEVICE

(71) Applicant: SK hynix Inc., Icheon-si (KR)

(72) Inventors: Dong Wook KIM, Icheon-si (KR); Min Cheol KWON, Icheon-si (KR); Duck Joo LEE, Icheon-si (KR); Han Bin LEE, Icheon-si (KR); Jae Hoon HEO, Icheon-si (KR)

(21) Appl. No.: 19/038,090

(22) Filed: Jan. 27, 2025

(30) Foreign Application Priority Data
Oct. 7, 2024 (KR) 10-2024-0135299

(51) Int. Cl. G06F 3/06

(52) U.S. Cl. CPC G06F 3/0613; G06F 3/064; G06F 3/0659; G06F 3/0673

(57) ABSTRACT

A storage device may include a memory and a controller. The memory may include a plurality of memory blocks. The controller may set a plurality of super memory blocks, each including at least one of the plurality of memory blocks, may receive, from a host, a write command requesting writing of a plurality of data units, the write command including N tags, each tag indicating a super memory block to which at least one of the plurality of data units is to be written, and may write the plurality of data units to N target super memory blocks corresponding to the N tags, respectively, among the plurality of super memory blocks.

### CROSS-REFERENCE TO RELATED APPLICATION

The present application claims priority under 35 U.S.C. § 119(a) to Korean Patent Application No. 10-2024-0135299 filed in the Korean Intellectual Property Office on Oct. 7, 2024, which is incorporated herein by reference in its entirety.

### BACKGROUND

### 1. Technical Field

Embodiments of the present disclosure generally relate to a storage device for writing data to super memory blocks corresponding to tags, and a method for operating the storage device.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

A storage device may serve multiple users. To ensure consistent performance (e.g., throughput and latency) across users, the storage device needs to efficiently manage its resources used for an operation of writing data, given the inherent limitations of its available resources.

### SUMMARY

Various embodiments of the present disclosure are directed to providing a storage device capable of optimizing the performance of an operation of writing data to super memory blocks in resource-constrained environments, and a method for operating the storage device.

In an aspect, a storage device may include: a memory including a plurality of memory blocks; and a controller configured to set a plurality of super memory blocks, each including at least one of the plurality of memory blocks, receive, from a host, a write command requesting writing of a plurality of data units, the write command including N (N is a natural number) tags, each tag indicating a super memory block to which at least one of the plurality of data units is to be written; and write the plurality of data units to N target super memory blocks corresponding to the N tags, respectively, among the plurality of super memory blocks.

In another aspect, a method for operating a storage device may include: setting a plurality of super memory blocks, each including at least one of a plurality of memory blocks; receiving, from a host, a write command requesting writing of a plurality of data units, the write command including N (N is a natural number) tags, each tag indicating a super memory block to which at least one of the plurality of data units is to be written; and writing the plurality of data units to N target super memory blocks corresponding to the N tags, respectively, among the plurality of super memory blocks.

According to the embodiments of the present disclosure, it is possible to optimize the performance of an operation of writing data to super memory blocks in the resource-constrained environments.

### BRIEF DESCRIPTION OF THE DRAWINGS

FIG. 1 illustrates a storage device according to an embodiment of the present disclosure.

FIG. 2 illustrates a memory of FIG. 1.

FIG. 3 illustrates a storage device according to an embodiment of the present disclosure.

FIG. 4 illustrates a mapping relationship between N tags and N target super memory blocks according to an embodiment of the present disclosure.

FIG. 5 illustrates a stripe count for each of N target super memory blocks according to an embodiment of the present disclosure.

FIG. 6 illustrates an operation in which the storage device according to the embodiment of the present disclosure writes data units to a target super memory block based on a stripe count.

FIG. 7 illustrates an example in which the storage device according to the embodiment of the present disclosure determines a stripe count for each of N target super memory blocks.

FIG. 8 illustrates another example in which the storage device according to the embodiment of the present disclosure determines a stripe count for each of N target super memory blocks.

FIG. 9 illustrates still another example in which the storage device according to the embodiment of the present disclosure determines a stripe count for each of N target super memory blocks.

FIG. 10 illustrates a method for operating a storage device according to an embodiment of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

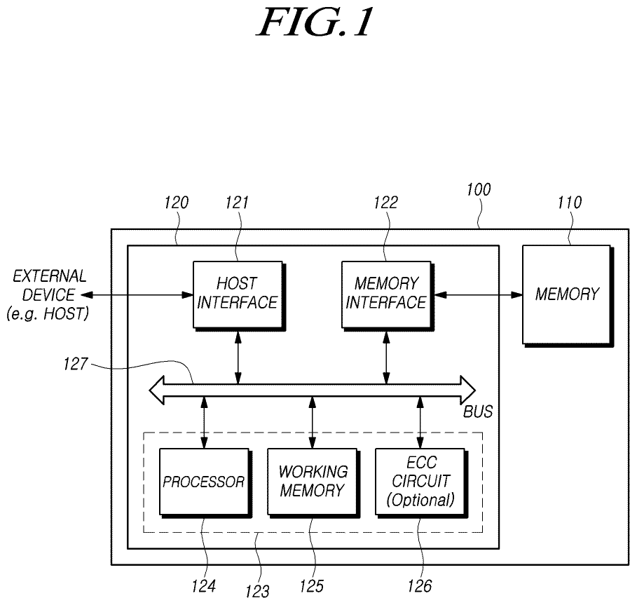

FIG. 1 illustrates a storage device 100 according to an embodiment of the disclosure.

Referring to FIG. 1, the storage device 100 may include a memory 110 that stores data and a controller 120 that controls the memory 110.

The memory 110 includes a plurality of memory blocks, and operates under the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), and so forth.

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (or program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request from the host.

The host may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 under the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (or drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or has failed. On the other hand, when a bit error rate is lower than the reference value, the error detection and correction circuit 126 may determine that a corresponding sector is correctable or has passed.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

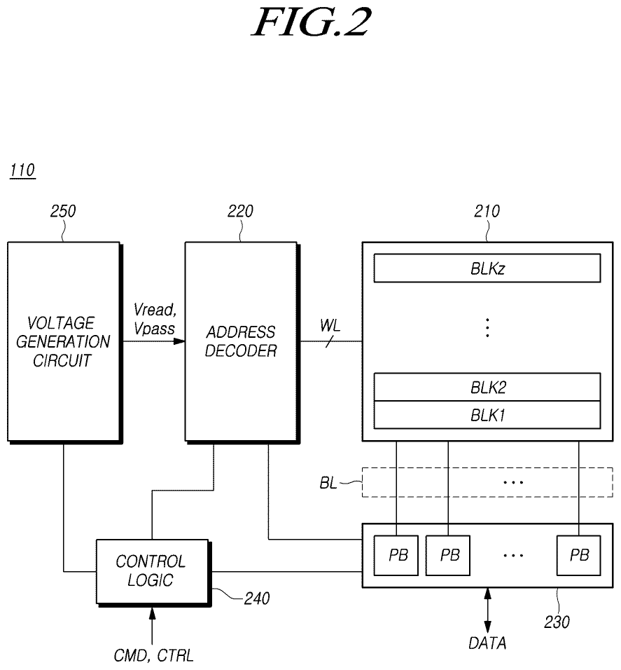

Hereinbelow, the memory 110 will be described in further detail with reference to FIG. 2.

FIG. 2 illustrates the memory 110 of FIG. 1.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal output from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

FIG. illustrates a storage device 100 according to an embodiment of the present disclosure.

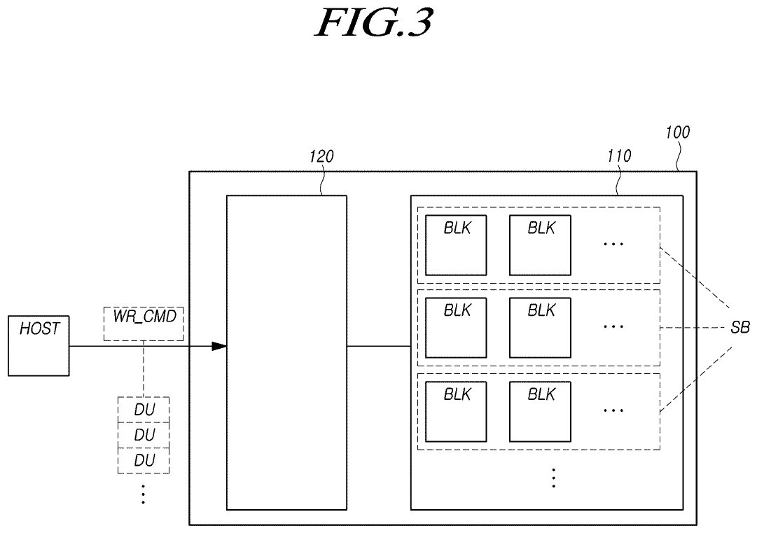

Referring to FIG. 3, the storage device 100 may include a memory 110 and a controller 120.

The memory 110 may include a plurality of memory blocks BLK.

The controller 120 may configure a plurality of super memory blocks SB. Each of the plurality of super memory blocks SB may include one or more memory blocks BLK selected from the plurality of memory blocks BLK.

Data may be written in parallel to the memory blocks BLK included in each of the plurality of super memory blocks SB. For example, each of the plurality of memory blocks BLK may be included in one of a plurality of memory dies (not illustrated) included in the memory 110, and the memory blocks BLK included in each of the plurality of super memory blocks SB may be included in different memory dies.

The controller 120 may receive a write command WR_CMD from a host HOST requesting the writing of a plurality of data units DU. In response to the write command WR_CMD, the controller 120 may write the plurality of data units DU to the memory 110.

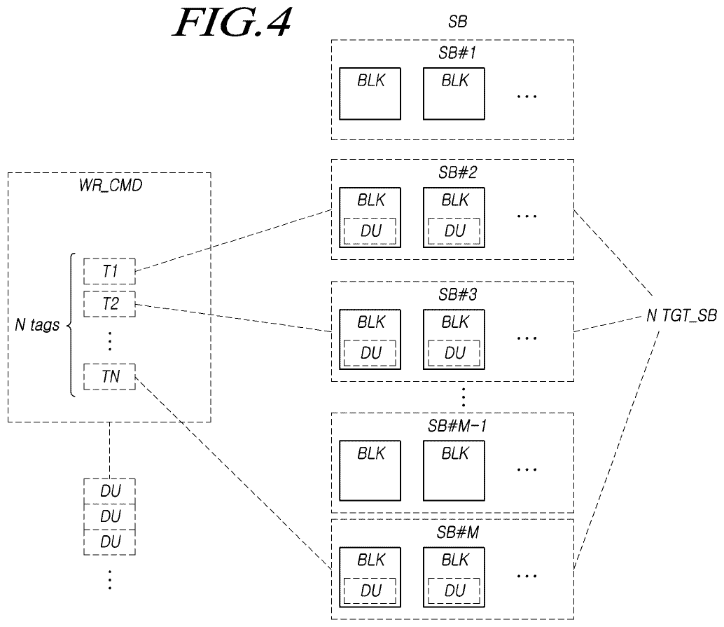

The write command WR_CMD may include tags, each indicating a super memory block to which at least one of the plurality of data units DU is to be written. This will be described in detail below with reference to FIG. 4.

FIG. 4 illustrates a mapping relationship between N tags T1, T2, . . . , TN and N target super memory blocks TGT_SB according to an embodiment of the present disclosure.

Referring to FIG. 4, a write command WR_CMD may include N tags T1, T2, . . . , TN. Each of the N tags T1, T2, . . . , TN may indicate a super memory block to which at least one of a plurality of data units DU is to be written. Each tag may represent a value identifying a location (area) in the memory 110 where one or more data units DU, as specified by the write command WR_CMD, are to be stored.

The tag may be referred to as a placement identifier, a hint, or the like.

The controller 120 of the storage device 100 may transmit a maximum value of N to the host HOST. By referring to the received maximum value, the host HOST may determine N as a value equal to or smaller than the received maximum value.

The controller 120 may read the N tags T1, T2, . . . , TN in the write command WR_CMD, and may write the plurality of data units DU to the N target super memory blocks TGT_SB corresponding to the N tags T1, T2, . . . , TN, respectively.

In FIG. 4, a tag T1 corresponds to a target super memory block SB#2, a tag T2 corresponds to a target super memory block SB#3, and a tag TN corresponds to a target super memory block SB#M.

Accordingly, the controller 120 may store the data units DU in the N target super memory blocks TGT_SB including the target super memory block SB#2, the target super memory block SB#3, . . . , the target super memory block SB#M.

In embodiments of the present disclosure, the N target super memory blocks TGT_SB corresponding to the N tags T1, T2, . . . , TN, respectively, are not limited to those illustrated in FIG. 4. The N target super memory blocks TGT_SB may be any N number of super memory blocks among a plurality of super memory blocks SB.

The controller 120 may manage a mapping relationship between the N tags T1, T2, . . . , TN and the N target super memory blocks TGT_SB using a separate mapping table.

By using the mapping table, the controller 120 may set a handle corresponding to each tag, and may dynamically set a target super memory block corresponding to the handle. Accordingly, the controller 120 may change a target super memory block corresponding to a specific tag. For example, when a target super memory block corresponding to a specific tag transitions to a closed state, the controller 120 may assign a different super memory block as the new target for the specific tag. In other words, the specific tag may be reassigned to a new target super memory block.

In order to write the plurality of data units DU to the N target super memory blocks TGT_SB, the controller 120 should allocate resources to manage the N target super memory blocks TGT_SB. Therefore, required internal resources increase significantly compared to writing data to only one or two super memory blocks. However, since resources available to the controller 120 are limited, it may not be possible to allocate maximum resources to all N target super memory blocks TGT_SB.

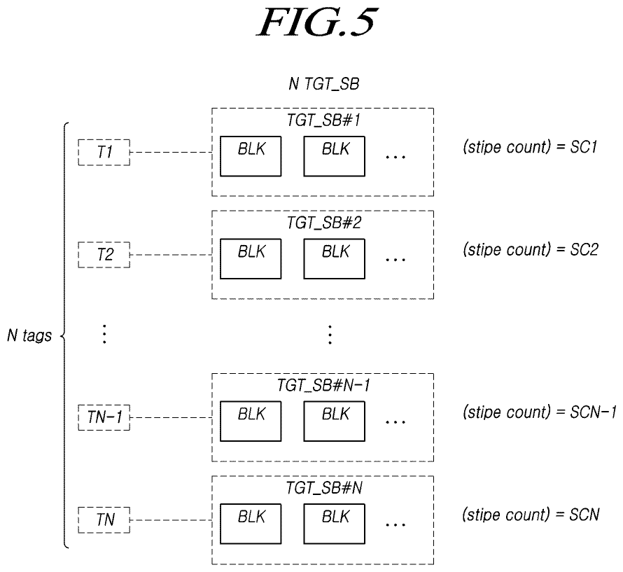

In this situation, in order to optimize write performance for the plurality of data units DU, the controller 120 may dynamically determine write performance for each target super memory block. This process will be described in detail below with reference to FIG. 5.

FIG. 5 illustrates a stripe count for each of N target super memory blocks TGT_SB according to an embodiment of the present disclosure.

Referring to FIG. 5, the controller 120 of the storage device 100 may determine a stripe count for each of the N target super memory blocks TGT_SB.

In FIG. 5, a stripe count of a target super memory block TGT_SB#1 corresponding to a tag T1 is SC1, a stripe count of a target super memory block TGT_SB#2 corresponding to a tag T2 is SC2, a stripe count of a target super memory block TGT_SB#N−1 corresponding to a tag TN−1 is SCN−1, and a stripe count of a target super memory block TGT_SB#N corresponding to a tag TN is SCN.

A stripe count for each target super memory block represents the number of data units that can be written in parallel to the target super memory block. Based on the stripe count for each target super memory block, the controller 120 may dynamically determine resources required for a write operation, such as the buffer size and processing time, for each target super memory block.

The controller 120 may allocate resources for each target super memory block from a preset common resource pool. If a target super memory block does not perform a write operation for at least a predetermined time (e.g., 10 minutes.), the controller 120 may return the allocated resources to the common resource pool.

As a stripe count for a target super memory block increases, the total size of data units that can be written simultaneously to the corresponding target super memory block also increases, thereby improving write performance for the corresponding target super memory block.

However, as the size of resources required to write more data simultaneously to the corresponding target super memory block increase, the limited resource capacity of the controller 120 makes it impossible to infinitely increase stripe counts for all target super memory blocks.

Therefore, by dynamically adjusting the stripe count for each of the N target super memory blocks TGT_SB, the controller 120 can optimize write performance while operating within the constraints of limited resources.

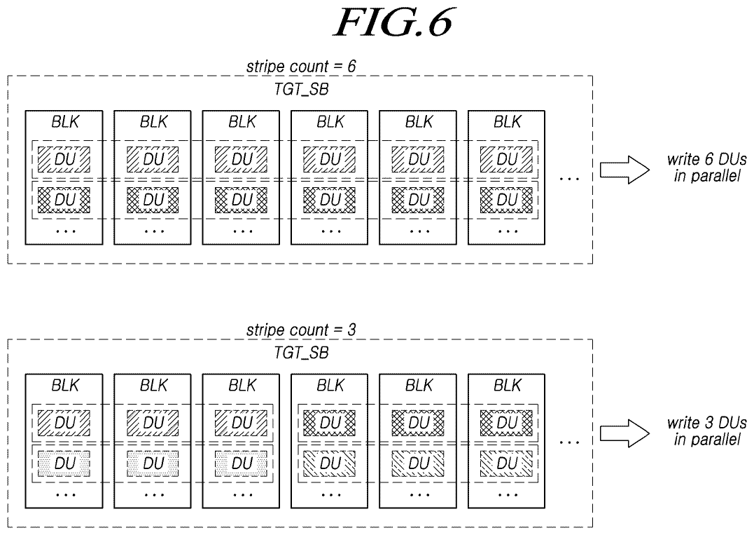

FIG. 6 illustrates an operation in which the storage device 100 according to the embodiment of the present disclosure writes data units DU to a target super memory block TGT_SB based on a stripe count.

When the stripe count for the target super memory block TGT_SB is 6, six data units DU may be written in parallel to the corresponding target super memory block TGT_SB. To achieve this, resources capable of temporarily storing the six data units DU are required.

On the other hand, when the stripe count for the target super memory block TGT_SB is 3, three data units DU may be written in parallel to the corresponding target super memory block TGT_SB. In this case, since the number of data units to be written at once is smaller than that when the stripe count is 6, the speed of writing data units DU decreases. However, since resources capable of temporarily storing the three data units DU are required, the size of resources to be used is reduced compared to when the stripe count is 6.

Hereafter, specific embodiments in which the storage device 100 determines a stripe count for each of N target super memory blocks TGT_SB will be described.

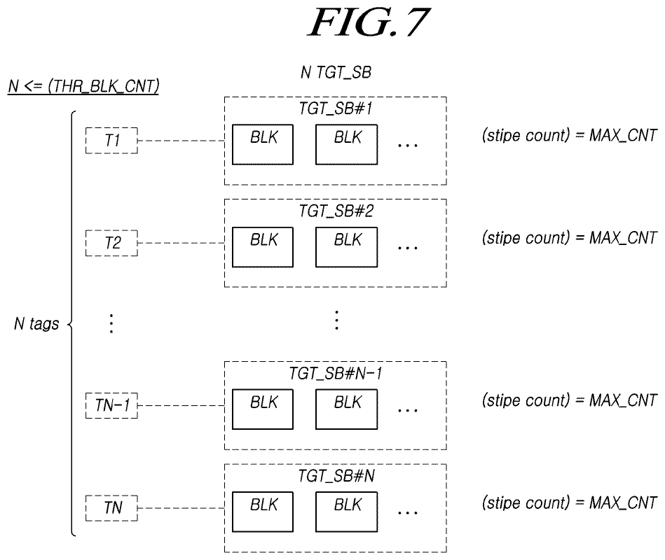

FIG. 7 illustrates an example in which the storage device 100 according to the embodiment of the present disclosure determines a stripe count for each of N target super memory blocks TGT_SB.

Referring to FIG. 7, when N is equal to or smaller than a set threshold super memory block count THR_BLK_CNT, the controller 120 of the storage device 100 may determine the stripe count for each of the N target super memory blocks TGT_SB as a preset maximum stripe count MAX_CNT.

This is because, when N is equal to or smaller than the threshold super memory block count THR_BLK_CNT, resources can be allocated to provide maximum write performance to all users of the storage device 100.

The maximum stripe count MAX_CNT may represent the number of memory blocks included in each target super memory block TGT_SB.

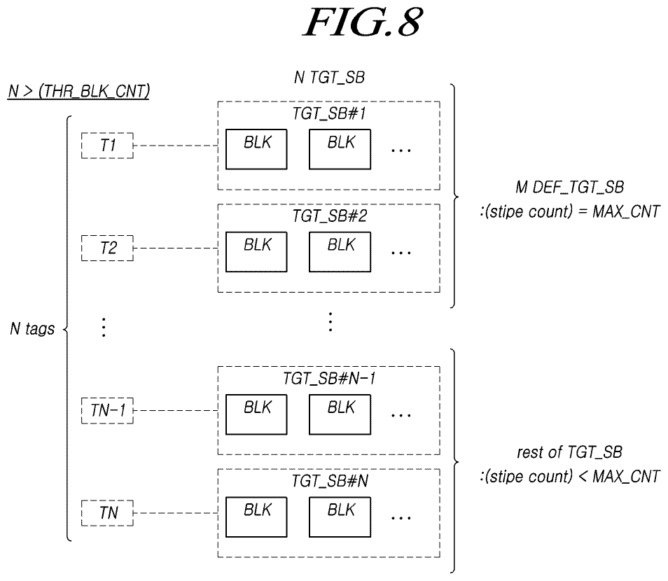

FIG. 8 illustrates another example in which the storage device 100 according to the embodiment of the present disclosure determines a stripe count for each of N target super memory blocks TGT_SB.

Referring to FIG. 8, when N is greater than the threshold super memory block count THR_BLK_CNT, the controller 120 of the storage device 100 may adjust the stripe count differently across the N target super memory blocks TGT_SB.

In FIG. 8, the controller 120 may set the stripe count for each of M default target super memory blocks DEF_TGT_SB to the maximum stripe count MAX_CNT. M is a natural number smaller than N. Specifically, M may be smaller than the threshold super memory block count THR_BLK_CNT.

On the other hand, the controller 120 may set the stripe count for each of the remaining target super memory blocks, excluding the M default target super memory blocks DEF_TGT_SB, to a value smaller than the maximum stripe count MAX_CNT.

When N is greater than the threshold super memory block count THR_BLK_CNT, the controller 120 cannot allocate sufficient resources to achieve maximum performance for all target super memory blocks TGT_SB. Therefore, in order to reduce resources allocated to the remaining target super memory blocks, the controller 120 may set the stripe count for each of the remaining target super memory blocks to a value smaller than the maximum stripe count MAX_CNT.

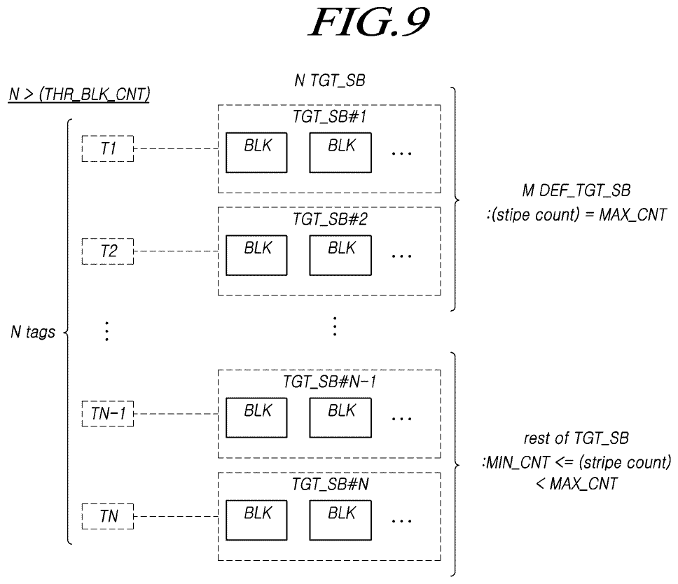

FIG. 9 illustrates still another example in which the storage device 100 according to the embodiment of the present disclosure determines a stripe count for each of N target super memory blocks TGT_SB.

Referring to FIG. 9, when N is greater than the threshold super memory block count THR_BLK_CNT, the controller 120 of the storage device 100 may set the stripe count for each of the remaining target super memory blocks, excluding the M default target super memory blocks DEF_TGT_SB, to a value equal to or greater than a minimum stripe count MIN_CNT and smaller than the maximum stripe count MAX_CNT.

This is to prevent delays in completing a write operation for all N target super memory blocks TGT_SB in a case where a write operation for the remaining target super memory blocks is not performed.

The controller 120 may set the stripe counts for the respective remaining target super memory blocks to be the same.

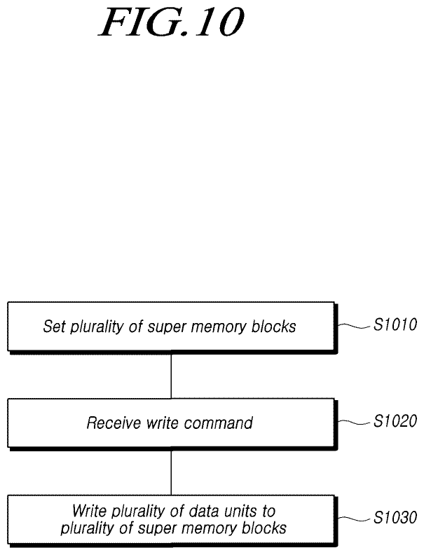

FIG. 10 illustrates a method for operating the storage device 100 according to an embodiment of the present disclosure.

Referring to FIG. 10, the method may include step S1010, which involves setting a plurality of super memory blocks SB, each including at least one of the plurality of memory blocks BLK included in the memory 110.

The method may include step S1020, which involves receiving a write command WR_CMD from the host HOST. The command requests the writing of a plurality of data units DU and includes N tags (N being a natural number), each indicating a super memory block where at least one of the plurality of data units DU is to be written.

The method may include step S1030, which involves writing the plurality of data units DU to N target super memory blocks TGT_SB corresponding to the N tags, respectively, among the plurality of super memory blocks SB.

For example, the step S1030 may include determining a stripe count for each of the N target super memory blocks TGT_SB based on the value of N. The stripe count for each target super memory block represents the number of data units that can be written in parallel to the target super memory block.

For example, the step of determining the stripe count for each of the N target super memory blocks TGT_SB may involve setting the stripe count for each of the N target super memory blocks TGT_SB to a preset maximum stripe count MAX_CNT when N is equal to or smaller than a set threshold super memory block count THR_BLK_CNT.

For example, the step of determining the stripe count for each of the N target super memory blocks TGT_SB may involve setting the stripe count for each of M default target super memory blocks DEF_TGT_SB, where M is a natural number smaller than N, to the maximum stripe count MAX_CNT. The stripe count for each of the remaining target super memory blocks, excluding the M default target super memory blocks DEF_TGT_SB, may be set to a value smaller than the maximum stripe count MAX_CNT.

The stripe count for each of the remaining target super memory blocks may be equal to or greater than a set minimum stripe count MIN_CNT.

The stripe counts for the respective remaining target super memory blocks may be set to be the same.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device, comprising:
a memory including a plurality of memory blocks; and
a controller configured to:
set a plurality of super memory blocks, each including at least one of the plurality of memory blocks;
receive, from a host, a write command requesting writing of a plurality of data units, the write command including N tags, each tag indicating a super memory block to which at least one of the plurality of data units is to be written; and
write the plurality of data units to N target super memory blocks corresponding to the N tags, respectively, among the plurality of super memory blocks,
wherein N is a natural number.

2. The storage device according to claim 1, wherein:
the controller determines a stripe count for each of the N target super memory blocks based on a value of N, and
the stripe count for each of the N target super memory blocks represents a number of data units that can be written in parallel to the target super memory block.

3. The storage device according to claim 2, wherein when N is equal to or smaller than a set threshold super memory block count, the controller sets the stripe count for each of the N target super memory blocks to a maximum stripe count.

4. The storage device according to claim 3, wherein:
when N is greater than the threshold super memory block count, the controller sets a stripe count for each of M default target super memory blocks among the N target super memory blocks to the maximum stripe count, and sets a stripe count of each of remaining target super memory blocks, excluding the M default target super memory blocks, to a value smaller than the maximum stripe count, and
M is a natural number smaller than N.

5. The storage device according to claim 4, wherein the controller sets the stripe count for each of the remaining target super memory blocks to be equal to or greater than a minimum stripe count.

6. The storage device according to claim 5, wherein the controller determines the stripe counts for the remaining target super memory blocks to be the same with each other.

7. A method for operating a storage device, the method comprising:
setting a plurality of super memory blocks, each including at least one of a plurality of memory blocks;
receiving, from a host, a write command requesting writing of a plurality of data units, the write command including N tags, each tag indicating a super memory block to which at least one of the plurality of data units is to be written; and
writing the plurality of data units to N target super memory blocks corresponding to the N tags, respectively, among the plurality of super memory blocks,
wherein N is a natural number.

8. The method according to claim 7,
wherein the writing the plurality of data units comprises:
determining a stripe count for each of the N target super memory blocks based on a value of N, and
wherein the stripe count for each of the N target super memory blocks represents a number of data units that can be written in parallel to the target super memory block.

9. The method according to claim 8, wherein the determining a stripe count for each of the N target super memory blocks includes setting, when N is equal to or smaller than a threshold super memory block count, the stripe count of each of the N target super memory blocks to a maximum stripe count.

10. The method according to claim 9,
wherein the determining a stripe count for each of the N target super memory blocks includes:
when N is greater than the threshold super memory block count,
setting a stripe count for each of M default target super memory blocks among the N target super memory blocks to the maximum stripe count; and
setting a stripe count for each of remaining target super memory blocks, excluding the M default target super memory blocks to a value smaller than the maximum stripe count,
wherein M is a natural number smaller than N.

11. The method according to claim 10, wherein the stripe count for each of the remaining target super memory blocks is equal to or greater than a minimum stripe count.

12. The method according to claim 11, wherein the stripe counts of the remaining target super memory blocks are set to be the same with each other.
